(19) United States
(12) Patent Application Publication
(10) Pub. No.: US 2013/0324386 A1
(43) Pub. Date: Dec. 5, 2013

(54) BAG MAKING MACHINE

(71) Applicant: Yao-Chang LIN, Taichung City (JP)

(72) Inventor: Yao-Chang LIN, Taichung City (JP)

(21) Appl. No.: 13/904,494

(22) Filed: May 29, 2013

(30) Foreign Application Priority Data
May 30, 2012 (TW) 101210343

(51) Int. Cl. B31B 49/04

(52) U.S. Cl. CPC B31B 49/04
USPC 493/264

(57) ABSTRACT

A bag making machine includes a feeder to unwind and feed a sheet in a first direction, a forming device to bend and fold the sheet to form a tubular body, a speed controller for controlling upstream and downstream speeds of advancement of the tubular body, a cutter to cut the tubular body into a plurality of tubular pieces, a direction changing device to change a direction of advancement of the tubular pieces so that the tubular pieces are advanced in a second direction substantially perpendicular to the first direction, a sewing device to sew and close an open bottom side of each of the tubular pieces, and a sealing device to hot press a sealing tape against the bottom side of each of the tubular pieces.

### CROSS-REFERENCE TO RELATED APPLICATION

This application claims priority of Taiwanese Application No. 101210343, filed on May 30, 2012.

### BACKGROUND OF THE INVENTION

1. Field of the Invention

The invention relates to a bag making machine, more particularly to a fully automatic bag making machine.

2. Description of the Related Art

Referring to FIG. 1, a conventional bag making machine 10 for making fabric bags 4 includes a printing device 11, a conveyer 12, a glue applicator 13, a forming device 14, a cutter 15, and an output belt 16. The conveyer 12 has a plurality of rollers 121 for conveying a continuous plastic fabric sheet (or a continuous paper sheet) 1, and the fabric sheet 1 is advanced to the glue applicator 13 after being printed with a predetermined pattern by the printing device 11. The glue applicator 13 applies glue to one of opposite lateral edges of the fabric sheet 1. The forming device 14 has a plurality of forming rollers 141 to bend and fold the glued fabric sheet 1 into a tubular body 2. The tubular body 2 is further conveyed to the cutter 15 to be cut into tubular pieces 3. Eventually, the tubular pieces 3 are gathered in a stack by the output belt 16.

However, the process of fabricating the fabric bags 4 has not finished by then since each of the tubular pieces 3 still has opposite openings. It is necessary to transport the stack of tubular pieces 3 to another manufacturing site for sewing manually bottom openings of the tubular pieces 3 to form the fabric bags 4.

The conventional bag making machine 10 is capable of forming a continuous fabric sheet 1 into a plurality of tubular pieces 3. However, the entire process of fabricating the fabric bags 4 needs to be divided into two parts since manual sewing takes longer time than making the tubular pieces 3 and cannot be synchronized with the operation of the conventional bag making machine 10. The two-part fabricating process is laborious and time-consuming.

Referring to FIG. 2, another conventional bag making machine 20 capable of automatically sewing bottom openings of tubular pieces includes a feeding unit 21, a cutter 22, a direction changing device 23, and a sewing unit 24. The feeding unit 21 has a roller 211 to feed a continuous fabric tubular body 5 into the cutter 22. The cutter 22 has a knife (not shown) to cut the tubular body 5 into tubular pieces 6. The tubular pieces 6 are then conveyed by the direction changing device 23 to change a direction of advancement and are advanced to the sewing unit 24. The sewing unit 24 has a sewing device 241 to sew and close a bottom opening of each of the tubular pieces 6 to complete fabricating of fabric bags 7. Although capable of sewing the bottom opening of each of the tubular pieces 6, the conventional bag making machine 20 cannot transform a fabric sheet into the tubular body 5. Moreover, in the fabricating process involving the use of the conventional bag making machine 20, it is difficult to coat a water-proof layer or an anti-slip layer on the tubular body 5 or the tubular pieces 6. As a result, the fabric bags 7 made by the conventional bag making machine 20 have inferior water-proof and anti-slip properties.

### SUMMARY OF THE INVENTION

Therefore, the object of the present invention is to provide a fully automatic bag making machine.

Accordingly, a bag making machine of the present invention comprises:

a feeder having a least one roller to unwind and feed a sheet in a first direction;

a forming device including
a glue extruder that is disposed downstream of and in line with the feeder to glue an edge of the sheet,
a forming unit that is disposed downstream of and in line with the glue extruder to bend and fold the sheet into a tubular body, and
a press roller that is disposed downstream of and in line with the forming unit to press the tubular body;

a speed controller including
a buffer frame that is disposed downstream of and in line with the forming device to guide advancement of the tubular body, and
a buffer device that is mounted on the buffer frame to control upstream and downstream speeds of advancement of the tubular body at upstream and downstream sides of the speed controller;

a cutter disposed downstream of and in line with the speed controller to cut the tubular body into a plurality of tubular pieces;

a direction changing device including a conveying unit that is disposed downstream of the cutter to change a direction of advancement of the tubular pieces so that the tubular pieces are advanced in a second direction substantially perpendicular to the first direction;

a sewing device disposed downstream of and in line with the conveying unit in the second direction to sew and close a bottom side of each of the tubular pieces, which is open; and

a sealing device including
a tape supply unit that is disposed downstream of and in line with the sewing device to supply a sealing tape for covering the bottom side of each of the tubular pieces that has been sewn and closed,
a hot press unit that is disposed downstream of and in line with the tape supply unit to hot press the sealing tape against the bottom side of each of the tubular pieces, and
a tape cutting unit that is disposed downstream of and in line with the hot press unit to cut the sealing tape.

### BRIEF DESCRIPTION OF THE DRAWINGS

Other features and advantages of the present invention will become apparent in the following detailed description of the preferred embodiment with reference to the accompanying drawings, of which:

FIG. 1 is a top view of a conventional bag making machine, illustrating a process of fabricating a fabric bag;

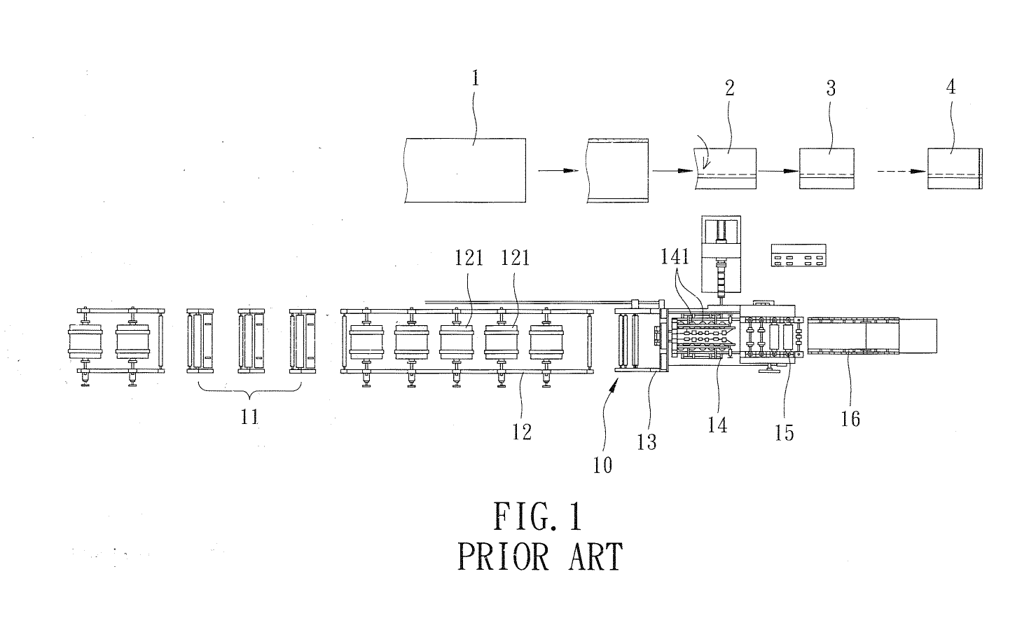

FIG. 2 is a top view of another conventional bag making machine, illustrating a process of fabricating a fabric bag;

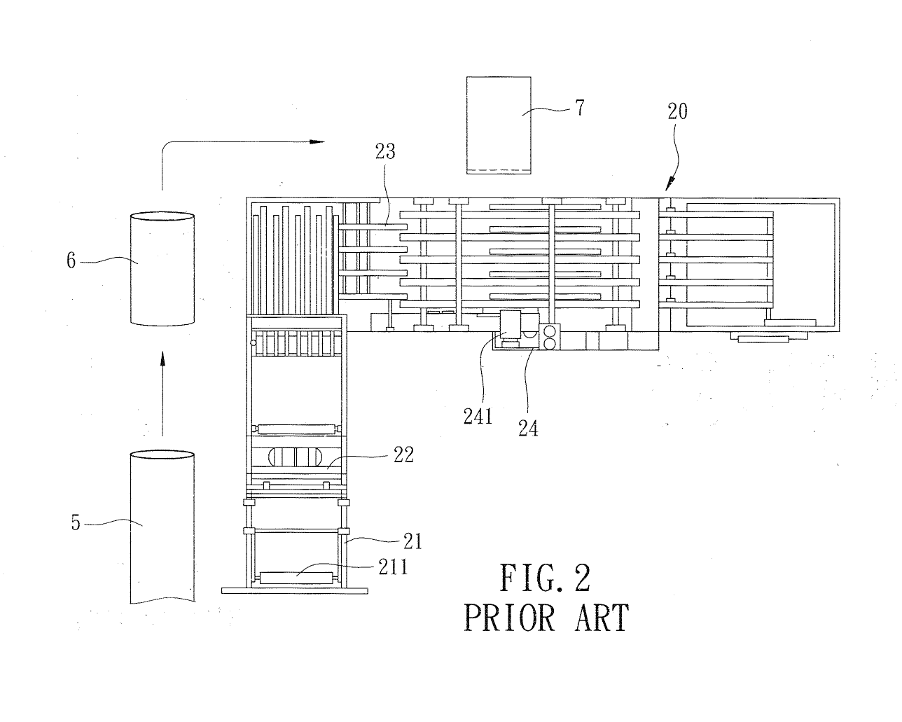

FIG. 3 is a side view of a tubular plastic bag made by a bag making machine according to the invention;

FIG. 4 is a side view of a tubular paper bag made by the bag making machine according to the invention;

FIG. 5 is a side view of a preferred embodiment of the bag making machine according to the invention;

FIG. 6 is a top view of the preferred embodiment;

FIG. 7 is a flow diagram of a fabricating process for the plastic bag conducted by the preferred embodiment;

FIG. 8 is a side view of a sealing device of the preferred embodiment;

FIG. 9 is a side view of a coating device of the preferred embodiment, illustrating a contact roller being in contact with a cooling roller; and

FIG. 10 is the same view as FIG. 9, but illustrating the contact roller being spaced apart from the cooling roller.

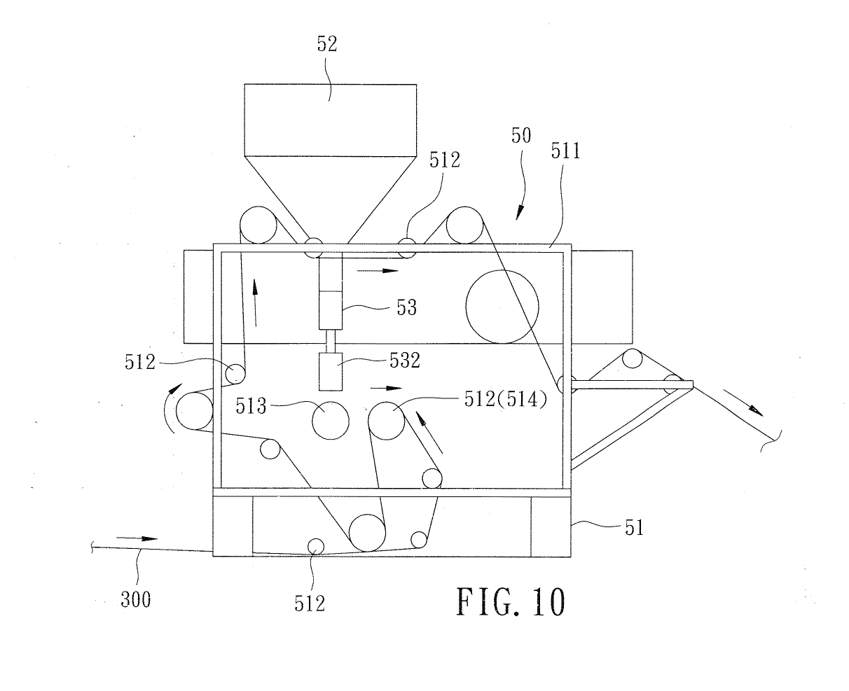

### DETAILED DESCRIPTION OF THE PREFERRED EMBODIMENT

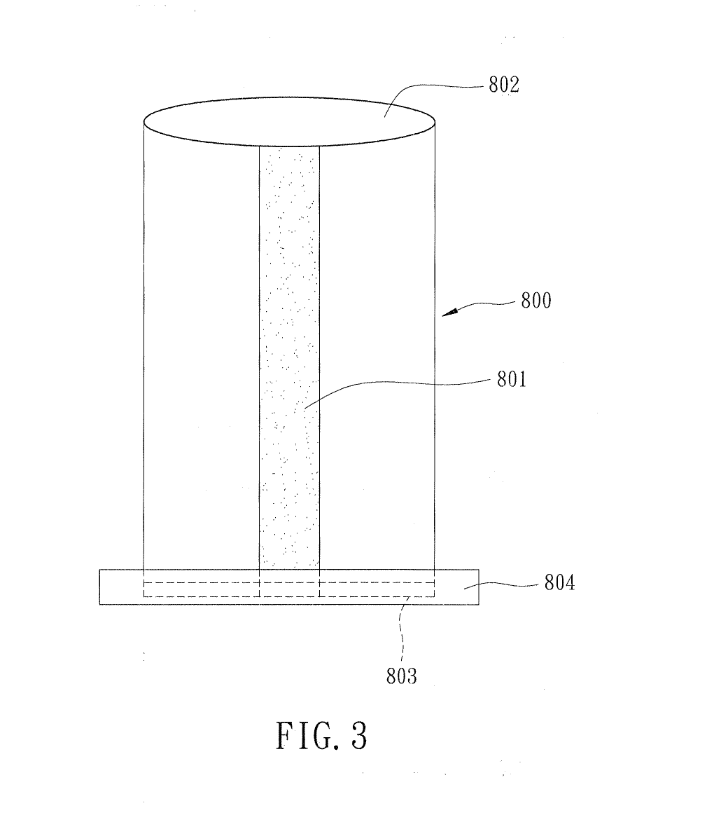

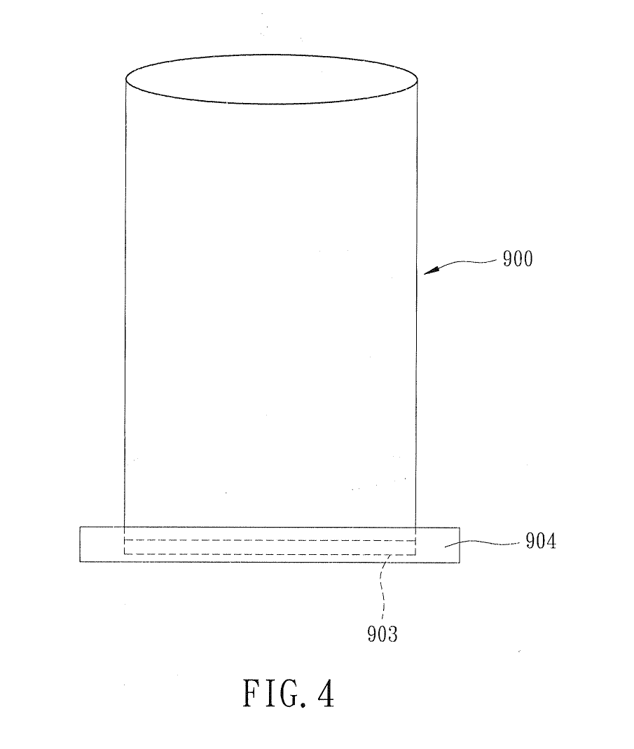

The present invention is directed to a bag making machine usable for making fabric bags. The preferred embodiment of the bag making machine according to the present invention is a fully automatic bag making machine capable of fabricating tubular bags from a fabric or paper sheet. Referring to FIG. 3, a fabric bag 800 made by the preferred embodiment is shown. An outer surface of the fabric bag 800 is coated with a plastic film to resist water. Moreover, since the plastic film is slippery, the fabric bag 800 is further coated with an anti-slip layer 801 so that, when multiple fabric bags 800 are used to package goods and are stacked for storage or transport, slippage between the fabric bags 800 can be avoided. The fabric bag 800 has an opening 802 and a sewed portion 803 opposite to the opening 802. The sewed portion 803 is sealed by a tape 804 to provide water-proof and dust-proof effects. The bag making machine of the preferred embodiment can also produce a paper bag 900 shown in FIG. 4. The paper bag 900 does not have any anti-slip layer, but still has a sewed portion 903 that has been sealed by a tape 904.

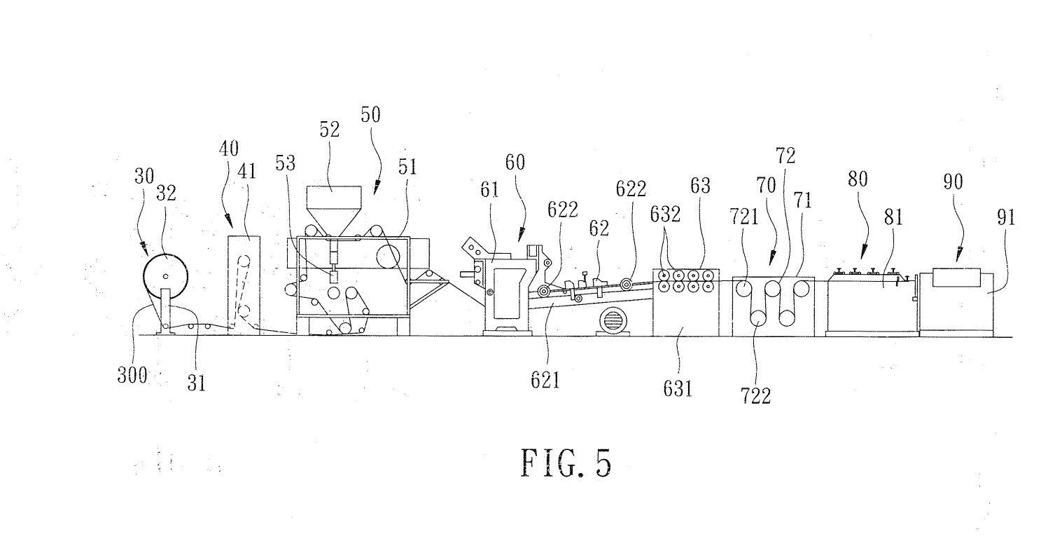

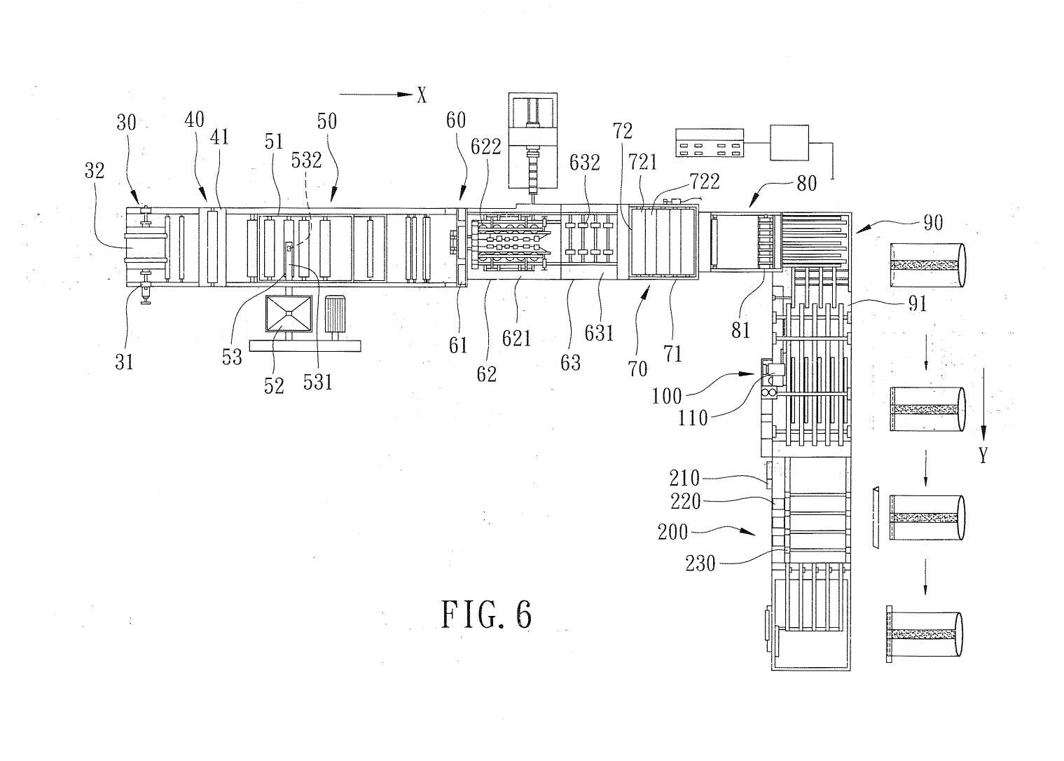

As shown in FIGS. 5 to 7, the preferred embodiment comprises a feeder 30, a printing device 40, a coating device 50, a forming device 60, a speed controller 70, a cutter 80, a direction changing device 90, a sewing device 100, and a sealing device 200.

The feeder 30 has a frame 31 and a roller 32 mounted on the frame 31 to unwind and feed a fabric sheet 300 in a first direction (X). In this embodiment, the fabric sheet 300 is a polypropylene (PP) sheet. For fabricating the paper bag 900 (see FIG. 4), the roller 32 will be used to feed a paper sheet.

The printing device 40 includes a printer 41 that is disposed in proximity to the feeder 30 to guide advancement of the fabric sheet 300 in the first direction (X) and to print a pattern on a surface of the fabric sheet 300.

The coating device 50 includes a support 51 disposed downstream of and in line with the printing device 40 to guide advancement of the fabric sheet 300, a coating extruder 52 disposed in proximity to the support 51 to supply an anti-slip coating material, and a coater 53 connected to the coating extruder 52 to apply the anti-slip coating material to the surface of the fabric sheet 300.

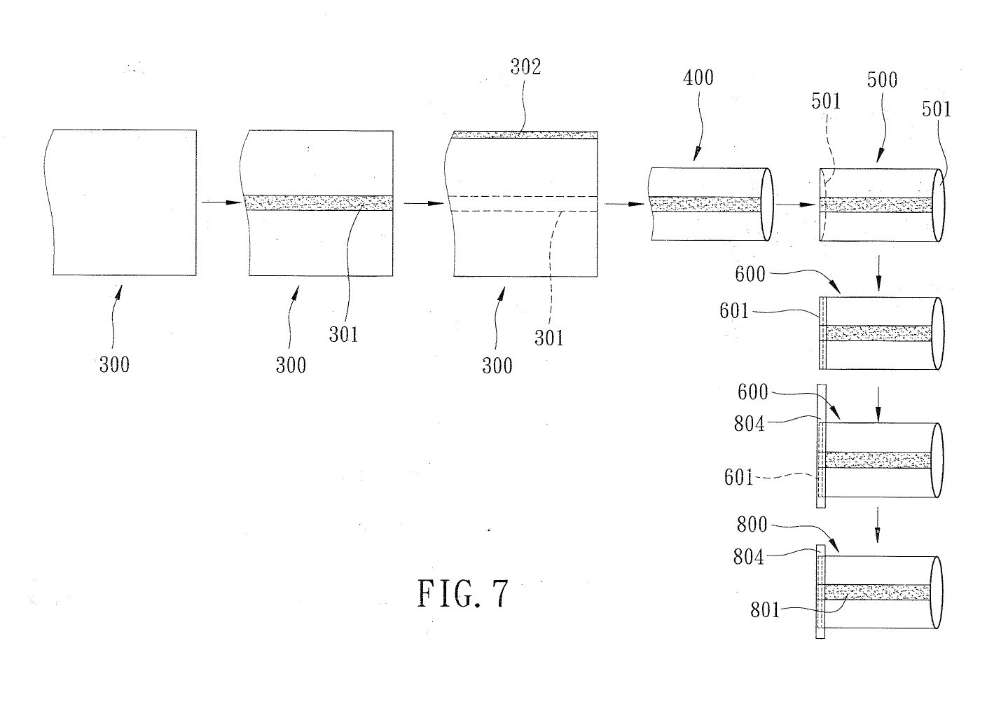

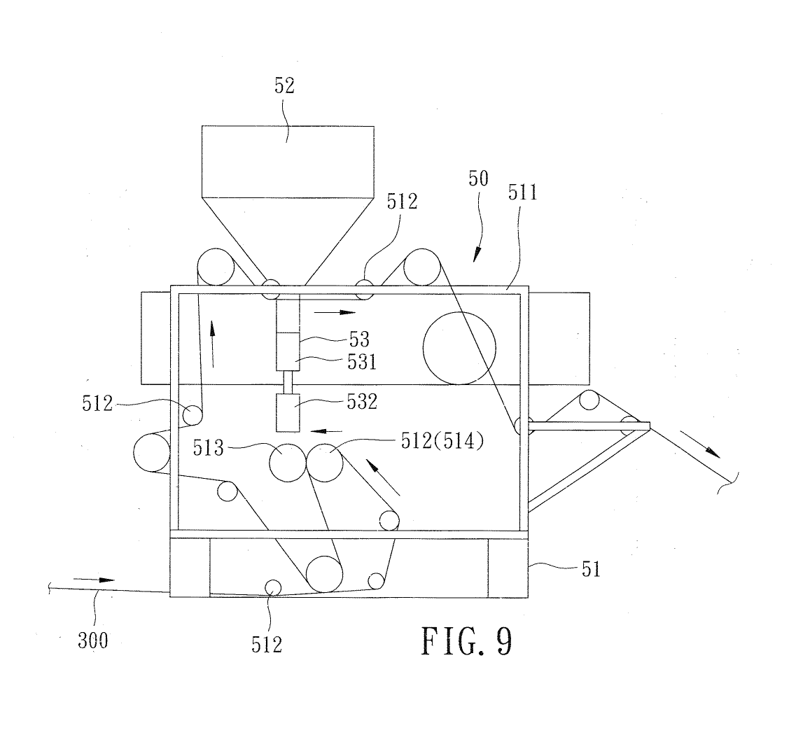

Referring further to FIG. 9, the support 51 includes a support body 511, a plurality of guide rollers 512 mounted rotatably on the support body 511 to permit the fabric sheet 300 to pass thereover, and a cooling roller 513 disposed substantially at a middle part of the support body 511. The guide rollers 512 include a movable contact roller 514 disposed substantially at the middle part in proximity to the cooling roller 513. The cooling roller 513 is disposed rotatably at a fixed position on the support body 511, and the contact roller 514 is capable of moving toward or away from the cooling roller 513 to guide the fabric sheet 300 to contact or move away from the cooling roller 513. The coater 53 includes an arm 531 disposed above the cooling roller 513, and a coating applicator head 532 attached to the arm 531 and connected to the coating extruder 52 to apply the anti-slip coating material to a surface of the cooling roller 513. When the contact roller 514 moves the fabric sheet 300 to contact the cooling roller 513, an anti-slip layer 301 is coated on the surface of the fabric sheet 300 (see FIG. 7)

Referring back to FIGS. 5 to 7, the forming device 60 includes a glue extruder 61 disposed downstream of and in line with the coating device 50, a forming unit 62 disposed downstream of and in line with the glue extruder 61, and a press unit 63 disposed downstream of and in line with the forming unit 62. The glue extruder 61 glues an edge 302 of the fabric sheet 300. The forming unit 62 includes a framework 621 and a plurality of forming rollers 622 mounted to opposite lateral sides of the framework 621 to bend and fold the fabric sheet 300 into a tubular body 400 (see FIG. 7). The press unit 63 has a framework 631 and a plurality of press rollers 632 mounted to the framework 631 to press the tubular body 400 for facilitating further advancement of the tubular body 400.

In the aforesaid upstream machine section of the preferred embodiment, the tubular body 400 is conveyed continuously and uninterruptedly. However, in the following downstream machine section of the preferred embodiment, the advancement of the tubular body 400 is intermittent because of the cutting operation, in which bag pieces are conveyed in a discrete manner. Because the upstream and downstream speeds at the upstream and downstream machine sections are different, the speed controller 70 is disposed therebetween for conditioning the upstream and downstream speeds of the advancement of the tubular body 400.

The speed controller 70 includes a buffer frame 71 that is disposed downstream of and in line with the forming device 60 to guide advancement of the tubular body 400, and a buffer device 72 that is mounted on the buffer frame 71 to control the upstream and downstream speeds of advancement of the tubular body 400 at upstream and downstream sides of the speed controller 70. The buffer device 72 includes a plurality of upper rollers 721 connected pivotally to an upper part of the buffer frame 71, and a plurality of translationally movable lower rollers 722 disposed below the upper rollers 721 and on a lower part of the buffer frame 71. The tubular body 400 is wound alternatively around the upper and lower rollers 721, 722. The lower rollers 722 move downward to displace away from the upper rollers 721 when the upstream speed is greater than the downstream speed of the advancement of the tubular body 400, and move upward to displace toward the upper rollers 721 when the upstream speed is smaller than the downstream speed of the advancement of the tubular body 400.

When a system (not shown) of the speed controller 70 detects that a downward movement of the lower rollers 722 reaches a predetermined lower level, the upstream speed of advancement of the tubular body 400 is decreased. When the system detects that an upward movement of the lower rollers 722 reaches a predetermined upper level, the upstream speed of advancement of the tubular body 400 is increased to surpass the downstream speed. The upstream and downstream speeds of advancement for the tubular body 400 are therefore regulated.

The cutter 80 includes a cutting unit 81 that is disposed downstream of and in line with the speed controller 70. Upper and lower cutting blades are utilized to shear the tubular body 400 into a plurality of tubular pieces 500, each of which has opposite openings 501 (see FIG. 7).

The direction changing device 90 includes a conveying unit 91 that is disposed downstream of the cutter 80 and that changes a conveying direction of the tubular pieces 500 to turn by an angle of 90 degrees so that the tubular pieces 500 are advanced in a second direction (Y) substantially perpendicular to the first direction (X). When each tubular piece 500 reaches the conveying unit 91, one of the openings 501 of the tubular piece 500 is oriented to face toward a lateral side of the direction changing device 90.

The sewing device 100 includes a sewing unit 110 that is disposed downstream of and in line with the conveying unit 91 in the second direction (Y) to sew and close said one of the openings 501 of each of the tubular pieces 500, such that the tubular pieces 500 are formed into bags 600, each of which has a sewed portion 601 (see FIG. 7).

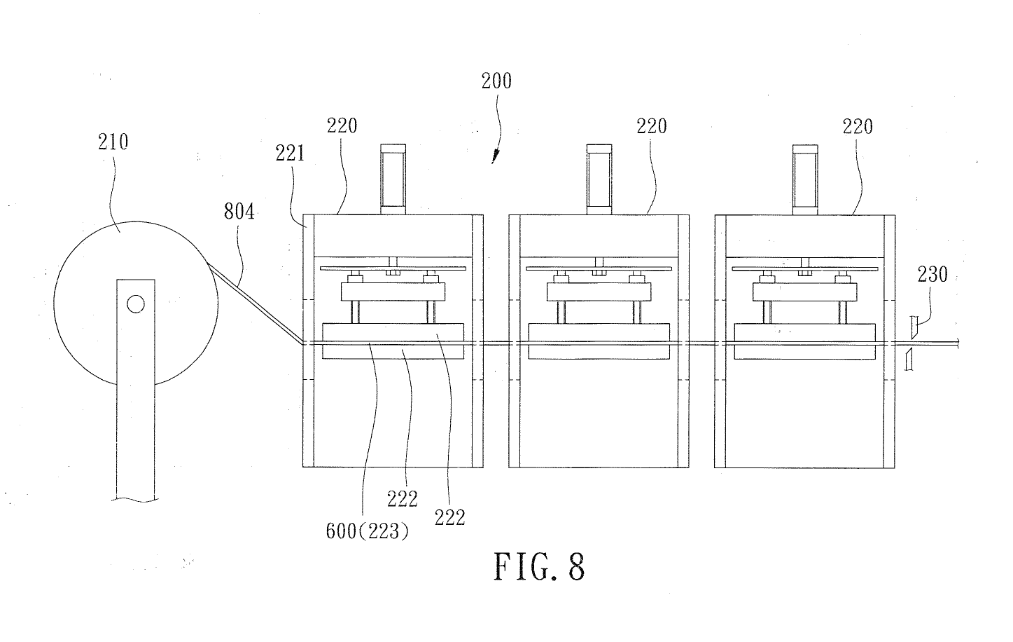

The sealing device 200 includes a tape supply unit 210 that is disposed downstream of and in line with the sewing device 100, a plurality of hot press units 220 that are disposed downstream of and in line with the tape supply unit 210, and a tape cutting unit 230 that is disposed downstream of and in line with the hot press units 220. Referring to FIG. 8, the tape supply unit 210 supplies a sealing tape 804 into the hot press units 220. The sealing tape 804 has a V-shaped cross-section and has an adhesive inner side for adhering and covering the sewed portion 601 of each of the bags 600. Each of the hot press units 220 includes a fixed seat 221, a pair of upper and lower press blocks 222 mounted on the fixed seat 221, and a passage 223 formed between the upper and lower press blocks 222 for the sewed portion 601 (see FIG. 7) of each of the bags 600 to pass therethrough. When the sewed portion 601 of each of the bags 600 enters the passage 223, the upper and lower press blocks 222 hot press the sealing tape 804 against the sewed portion 601. Finally, the tape cutting unit 230 cuts the sealing tape 804 to finish a fabricating process of the bag making machine for producing the fabric bags 800 (see FIG. 7).

The bag making machine may further comprise a counter (not shown) at a downstream side of the sealing device 200 to count the number of the fabric bags 800 fabricated by the bag making machine.

During the operations of the feeder 30, the printing device 40 and the forming device 60, an outer surface of the fabric sheet 300 is directed downward. However, in the coating device 50, because the outer surface of the fabric sheet 300 needs to face upward so as to be coated with the anti-slip layer 301, a surface reversing operation must be performed to reverse the outer surface of the fabric sheet 300.

Referring to FIG. 9, the guide rollers 512 are used to advance the fabric sheet 300, and the fabric sheet 300 passes through a lower part of the support 511 and winds around the contact roller 514 so that the fabric sheet 300 is reversed to cause the outer surface thereof to face upward. At this state, an operator may operate the contact roller 514 to contact the cooling roller 513. Because the surface of the cooling roller 513 receives the anti-slip coating material from the coating applicator head 532, the fabric sheet 300 is coated with the anti-slip coating material when contacting the cooling roller 513. Subsequently, the fabric sheet 300 is turned upward and conveyed outward from an upper part of the support 511, and the outer surface of the fabric sheet 300 is reversed once again to face downward for a subsequent operation.

For fabricating paper bags 900, no anti-slip layer is needed on the outer surface of the paper sheet. Therefore, when a paper sheet enters the coating device 50, the operator may control the coating applicator head 532 to stop spraying the anti-slip coating material and control the contact roller 514 to move away from the cooling roller 513.

To sum up, the bag making machine of this invention provides a fully automated production line for fabricating fabric bags 800 or paper bags 900. When the fabric bags 800 are produced, the coating device 50 may be controlled to supply the anti-slip coating material to the outer surface of the flat sheet 300. When the paper bags 900 are produced, the coating device 50 does not supply the anti-slip coating material to the outer surface of the paper sheet. The production capacity of the bag making machine is enhanced and the cost of manual operation is reduced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A bag making machine comprising:
a feeder having a least one roller to unwind and feed a sheet in a first direction;
a forming device including
a glue extruder that is disposed downstream of and in line with said feeder to glue an edge of the sheet,
a forming unit that is disposed downstream of and in line with said glue extruder to bend and fold the sheet into a tubular body, and
a press roller that is disposed downstream of and in line with said forming unit to press the tubular body;
a speed controller including
a buffer frame that is disposed downstream of and in line with said forming device to guide advancement of the tubular body, and
a buffer device that is mounted on said buffer frame to control upstream and downstream speeds of advancement of the tubular body at upstream and downstream sides of said speed controller;
a cutter disposed downstream of and in line with said speed controller to cut the tubular body into a plurality of tubular pieces;
a direction changing device including a conveying unit that is disposed downstream of said cutter to change a direction of advancement of the tubular pieces so that the tubular pieces are advanced in a second direction substantially perpendicular to the first direction;
a sewing device disposed downstream of and in line with said conveying unit in the second direction to sew and close a bottom side of each of the tubular pieces, which is open; and
a sealing device including
a tape supply unit that is disposed downstream of and in line with said sewing device to supply a sealing tape for covering the bottom side of each of the tubular pieces that has been sewn and closed,
a hot press unit that is disposed downstream of and in line with said tape supply unit to hot press the sealing tape against the bottom side of each of the tubular pieces, and
a tape cutting unit that is disposed downstream of and in line with said hot press unit to cut the sealing tape.

2. The bag making machine as claimed in claim 1, further comprising a printing device and a coating device,
said printing device being disposed in proximity to said feeder to guide advancement of the sheet in the first direction and to print a pattern on a surface of the sheet,
said coating device including
a support that is disposed downstream of and in line with said printing device to guide advancement of the sheet,
a coating extruder that is proximate to said support to apply an anti-slip coating material, and
a coater that is connected to said coating extruder to supply the anti-slip coating material for coating a surface of the sheet.

3. The bag making machine as claimed in claim 2, wherein said support of said coating device includes
a support body, and
a plurality of guide rollers that are mounted rotatably on said support body and that are arranged to convey and reverse the sheet.

4. The bag making machine as claimed in claim 3, wherein said support further includes a cooling roller disposed substantially at a middle part of said support body and in proximity to said coater to receive the anti-slip coating material delivered from said coater, said guide rollers including a movable contact roller disposed substantially at said middle part in proximity to said cooling roller, said contact roller permitting the sheet to pass thereover and being movable toward or away from said cooling roller such that the sheet is in contact or not in contact with the cooling roller.

5. The bag making machine as claimed in claim 4, wherein said coater of said coating device includes
an arm dispose above said codling roller, and
a coating applicator head attached to said arm and connected to said coating extruder to apply the anti-slip coating material to the surface of the sheet.

6. The bag making machine as claimed in claim 1, wherein said buffer device of said speed controller includes
a plurality of upper rollers connected pivotally to an upper part of said buffer frame to permit the tubular body to pass thereover, and
a plurality of translationally movable lower rollers disposed below said upper rollers and on a lower part of said buffer frame to permit the tubular body to pass thereover, said lower rollers being movable downward to displace away from said upper rollers and being movable upward to displace toward said upper rollers.

7. The bag making machine as claimed in claim 6, wherein said speed controller further includes a system that detects the upward or downward movement of said lower rollers, and then controls the upstream and downstream speeds of advancement of the tubular body.

8. The bag making machine as claimed in claim 1, wherein said hot press unit includes
a fixed seat,
a pair of upper and lower press blocks mounted on said fixed seat, and
a passage formed between said upper and lower press blocks for the bottom sides of the tubular pieces to pass therethrough.
